(19) United States
(12) Patent Application Publication
(10) Pub. No.: US 2003/0120918 A1
(43) Pub. Date: Jun. 26, 2003

(54) Hard drive security for fast boot

(75) Inventor: Kerry B. VanDer Kamp, Hillsboro, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/032,175

(22) Filed: Dec. 21, 2001

(51) Int. Cl. H04L 9/00

(52) U.S. Cl. 713/164

(57) ABSTRACT

Systems and methods secure a hard drive with a password. These systems and methods prevent unauthorized access to valuable data on the hard drive and prevent a hacker from sniffing the password as it is communicated over a bus. Data on the hard drive is protected, even if it is not encrypted. Responsibility for managing the security features is shared between the operating system and the BIOS in such a way as to maximize security and minimize boot time.

### BACKGROUND

Some computer systems take too long to execute the basic input-output system (BIOS) process, before starting to load the operating system. Some of the fastest BIOS programs still take five to ten seconds. A BIOS is a program that starts a computer system after it is turned on and manages communication between the operating system and other devices, such as a hard drive during boot. An operating system is a program that, after being loaded by a boot program, manages the applications running on a computer system. One example of an operating system is Linux. Booting means loading an operating system and other programs into a computer system's memory or random access memory (RAM). Once the operating system is loaded, it is ready to execute applications.

Computer systems store valuable content on hard drives. This content is protected in some systems by Advanced Technology Attachment (ATA) security features, which are described in “Information Technology—AT Attachment with Packet Interface-6” (ATA/ATAPI-6). The ATA/ATAPI-6 is a working draft in the process of being approved by the T13, the National Committee for Information Technology Standards (NCTS), and the American National Standards Institute (ANSI). The latest draft is available at www.t13.org. The ATA security features allow software to lock the hard drive with a password. On power up or reset, the hard drive firmware will disable all media access until the correct password has been sent. The BIOS in notebooks commonly uses this feature to lock the hard drive until a user enters the correct password to unlock it. Some systems require a hard drive to spin up before a locked hard drive can be unlocked with a password. A locked hard drive is inaccessible; the computer system will not work. Hard drive security features typically require the hard drive to spin up, which takes about five to ten seconds. Thus, it is impractical to wait in the BIOS to unlock the hard drive.

Hackers exploit weak points or vulnerabilities in security. It is possible for a hacker to disassemble a computer system and sniff a hard drive password on a bus as it is passed from the processor to the hard drive.

### BRIEF DESCRIPTION OF THE DRAWINGS

FIG. 1 is a block diagram of an example computer system illustrating embodiments of the present invention.

FIG. 2 is a block diagram of an example embodiment of an architecture for the computer system shown in FIG. 1.

FIGS. 3A is a flow chart illustrating an example method embodiment of the present invention.

FIG. 3B is another flow chart illustrating an example method embodiment of the present invention. In one embodiment the example method embodiments of FIGS. 3A and 3B are combined so that the embodiment begins in FIG. 3A until point “A”, continues in FIG. 3B and then returns to FIG. 3A at point “B.”

FIG. 4 is another flow chart illustrating an alternate embodiment of the present invention.

FIG. 5 is another flow chart illustrating a further embodiment of the present invention.

### DETAILED DESCRIPTION

Systems and methods of hard drive security for fast boot are described. The following detailed description refers to the drawings in this application. The drawings illustrate specific embodiments to practice the present invention and, in these drawings, the same reference numbers are used for substantially similar components. This application describes embodiments of the present invention in sufficient detail to enable those skilled in the art to practice embodiments of the present invention. In addition, other embodiments that vary in structural, logical, mechanical, and electrical ways do not depart from the scope of embodiments of the present invention.

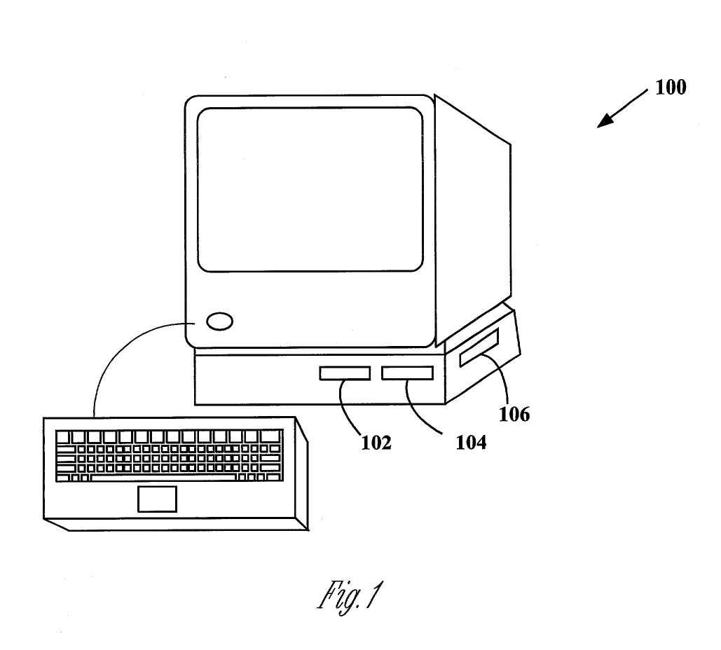

FIG. 1 is a block diagram of an example computer system 100 illustrating embodiments of the present invention. A computer system or computing device that includes a processor 102, a hard drive 104, and memory 106 is used for various embodiments of the present invention. The memory 106 may be inside the computer or accessible to it. The memory 106 is any type or combination of types of memory, such as random-access memory (RAM), read-only memory (ROM), flash memory, and the like. Flash memory (a/k/a flash RAM) is a type of constantly powered nonvolatile memory that can be erased and reprogrammed in units of memory called blocks. Flash memory often holds a BIOS. One example of such a computer system is an Internet appliance, such as the Intel® Dot. Station™ Web Appliance available from Intel Corporation, Santa Clara, Calif. The Intel® Dot.Station™ Web Appliance provides an easy-to-use real Internet experience and email access for non-technical consumers from a service provider. It includes a browser, a display, an email program, an operating system, audio/video and other input/output devices, a processor, memory, a modem, a hard drive, and other features.

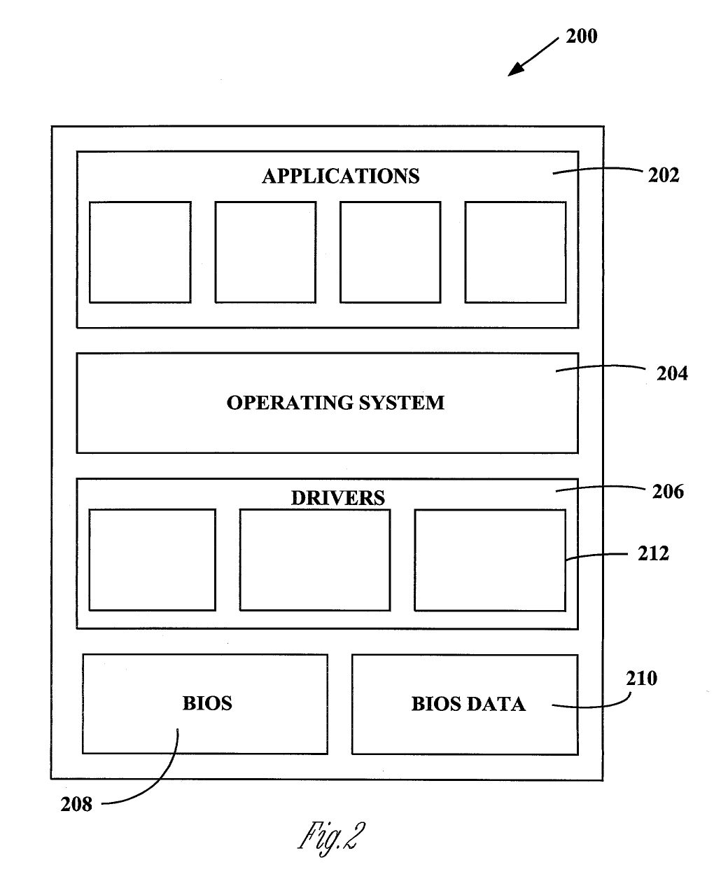

FIG. 2 is a block diagram of an example embodiment of an architecture for the computer system shown in FIG. 1. The example architecture 200 includes stored data and various programs to run on a processor, such as various applications 202, an operating system 204, a plurality of drivers 206, a BIOS 208, and BIOS data 210. The plurality of drivers 206 are programs that interact with particular devices or kinds of software in the computer system. Some examples of drivers are printer drivers, utility programs, and the like. These drivers are usually interfaces between applications 202 and the devices or software. BIOS data 210 is data stored in memory that is either within the BIOS 208 or accessible to the BIOS 208.

One embodiment of the present invention is a system comprising a processor, a hard drive coupled to the processor, an operating system 204, a BIOS 208, a password, and a plurality of drivers 206. The password is used to unlock the hard drive. One example of a password is a system-specific password that is unique to a computer system, such as a processor serial number. The operating system 204, BIOS 208, and drivers 206 execute on the processor. In one embodiment, a driver 212 from the plurality of drivers 206 executes from the operating system 204. In another embodiment, the operating system 204 is stored in flash memory and initialized before unlocking the hard drive. In another embodiment, a kernel and other modules of the operating system 204 are placed in flash memory so that boot times are faster and the time waiting for the hard drive to spin up is minimized. The kernel is the core of a computer operating system 204 and it provides basic services for all the other parts of the operating system 204.

In another embodiment, the password is stored in BIOS data 210 and is used to unlock the hard drive. This is performed by a driver 212 in the plurality of drivers 206. The driver 212 accesses the BIOS 208, which retrieves the password from the BIOS data 210 and returns the password to the driver 212. One example of a driver 212 is an integrated device electronics (IDE) driver. IDE is a standard electronic interface. Some embodiments of the present invention use the enhanced version (EIDE) of IDE, which has a disk drive controller built into the logic board in the disk drive.

In one embodiment, a driver 212 of the present invention requests a password for each locked hard drive from the BIOS 208 via a system management interrupt (SMI). SMIs are interrupts that are asserted by the operating system 204. The operating system 204 asserts SMIs by programming the chipset by, for example, filling in registers and toggling bits in the chipset. Once an SMI is asserted, system management software modules in the BIOS 208 handle the SMI. If the BIOS 208 determines it is safe to do so, the BIOS 208 returns the password to the driver 212. The driver 212 sends the password to unlock the hard drive and then freezes the lock mechanism to prevent tampering with the password. If the password is system-specific, access to the contents of a locked hard drive is only allowed on authorized systems. Thus, the password protected hard drive is only accessible and bootable on the system when it is secure.

In one embodiment, security components, such as password generation components, are placed in the BIOS 208 and SMI is used to access them. In this way, the security components are more difficult to hack. The BIOS 208 checks other security mechanisms like chassis intrusion before returning the hard drive password to the driver 212. This protects against snooping the password on a bus. By automating password generation in the BIOS 208 rather than querying the user, system-specific passwords are generated in the factory or during installation that are very difficult to crack.

Various embodiments of the present invention secure hard drives and prevent unauthorized access to valuable content on hard drives, such as information downloaded from the Internet. These embodiments protect data on a hard drive, even if it is not encrypted. In each embodiment, responsibility for managing the ATA security features is shared between the operating system 204 and the BIOS 208 in such a way as to maximize security and minimize boot time.

In one embodiment, a chassis intrusion mechanism provides physical security and detects when a computer system is opened or disassembled. The chassis intrusion mechanism alternates between a secure mode and a maintenance mode. Secure mode is the normal operating state, while maintenance mode permits maintenance to be performed on the computer system. The hard drive remains password protected in both the secure mode and the maintenance mode. An example of the maintenance mode is a chassis intrusion override mode that allows a computer system to be booted for maintenance purposes, even though chassis intrusion is activated. Once chassis intrusion is activated, the BIOS 208 will no longer retrieve a password to prevent a hacker from sniffing it off a system bus.

In another embodiment, the password is a serial number. One example is the processor serial number (PSN), which is a software-readable unique serial number to stamp into processors to provide certain network management and e-commerce benefits. The PSN uniquely identifies a processor. Another example is a system serial number a/k/a motherboard serial number, which is programmed in the factory and stored in the BIOS data area 210. It is associated with the motherboard and uniquely identifies the motherboard. In another embodiment, the password is encrypted. Encryption is the conversion of understandable plaintext into ciphertext that cannot be easily understood by unauthorized people. Any type of encryption can be used, such as Data Encryption Standard (DES), Rijndael, or simple adding, shifting, ORing and ANDing of bits.

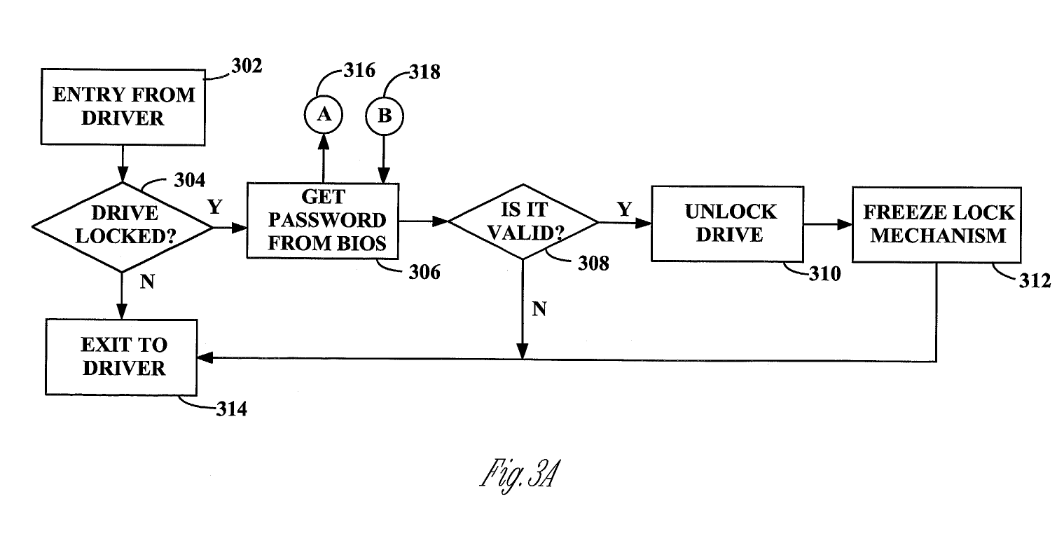

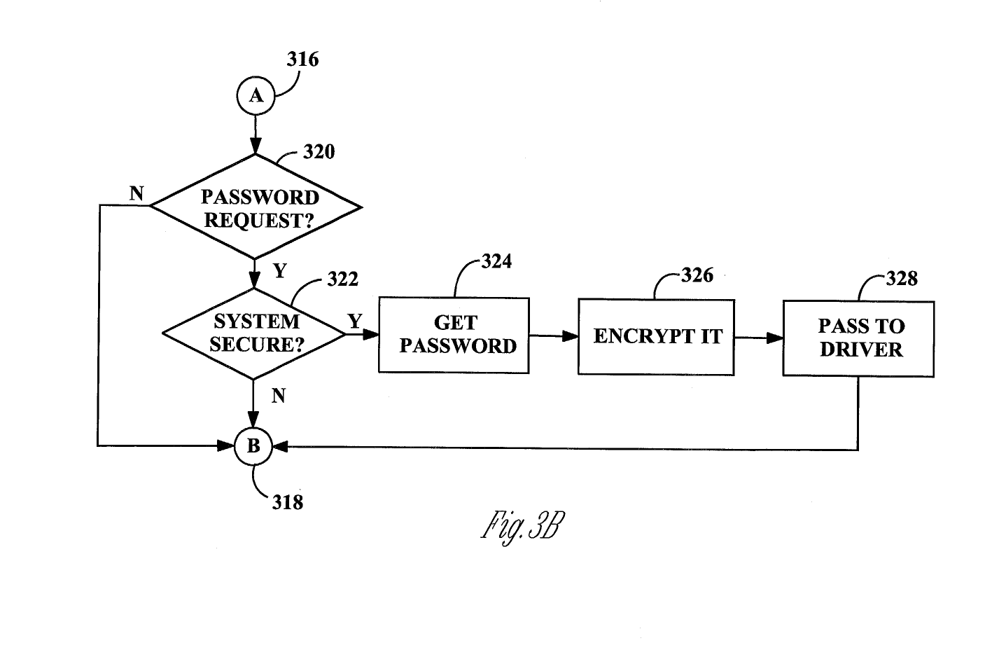

FIGS. 3A is a flow chart illustrating an example method embodiment of the present invention. FIG. 3A begins during execution of an IDE driver when a call is made to a driver 302. The driver checks to see if the hard drive is locked 304. If the hard drive is locked, then a password is retrieved from the BIOS 306. The retrieved password is checked for validity 308 and if it is valid, it is used to unlock the hard drive 310. An example of one way to determine if a password is valid is to initialize a buffer to zero, before the driver passes the address of a buffer to the BIOS. Upon return, the driver check the buffer to see if it is still zero. If the buffer is zero, then the driver program knows the BIOS did not return valid data by writing the password to the buffer. In this example, valid data is non-zero. When invalid data is detected control flows to exit the driver 314. Otherwise, the hard drive is unlocked 310 and the driver freezes the lock mechanism 312 and then exits back to the IDE driver 314. Once the hard drive is unlocked, all the other ATA drive security commands are available. Therefore, a hacker could disable the password or change the password. An example of how the driver freezes the lock mechanism is the ATA security freeze lock command. The freeze command prevents that kind of tampering. Once the security freeze lock command is executed, all of the security commands are disabled until power is cycled on the hard drive.

FIG. 3A illustrates operations performed in the operating system, while FIG. 3B illustrates operations performed in the BIOS. Another embodiment of the present invention comprises the operations performed in the operating system as shown in FIG. 3A. In this embodiment, an operating system determines whether or not a hard drive is locked 304. The operating system also retrieves a password from a BIOS 306 and unlocks the hard drive using the password 310. The operating system determines if the password is valid 308 and unlocks the hard drive 310 only if the password is valid. The operating system freezes a lock mechanism 312 for the hard drive.

FIG. 3B is another flow chart illustrating an example method embodiment of the present invention. In one embodiment the example method embodiments of FIGS. 3A and 3B are combined so that the embodiment begins in FIG. 3A until point “A” 316, continues in FIG. 3B and then returns to FIG. 3A at point “B” 318. The driver shown in FIG. 3A calls to the BIOS shown in FIG. 3B at point “A” 316 to get a password from the BIOS 306. After the password request from the driver program to the BIOS 320, the BIOS determines if the system is secure 322. As described above, chassis intrusion mechanism alternates between a secure mode and a maintenance mode. Therefore, the system is secure in the secure mode, but not in the maintenance mode. The BIOS does not return a password if the system is not secure; instead, it exits and returns to the driver 318. Otherwise, the BIOS retrieves the password 324. Some examples of passwords are a secure number associated with the processor, a system serial number, or a unique identifier tied to a component. Then, the BIOS encrypts the password 326 and passes it to the driver program 328 as it returns to the driver program in FIG. 3A at point “B” 318.

FIG. 3A illustrates operations performed in the operating system, while FIG. 3B illustrates operations performed in the BIOS. Another embodiment of the present invention comprises the operations performed in the BIOS as shown in FIG. 3B. In this embodiment, a machine-accessible medium has associated content capable of directing the machine to perform a method. A BIOS receives a password request 320 from an operating system. The BIOS determines if a system is in either the secure mode or the maintenance mode, as shown in the system secure block 322. If the system is not secure then control flows back to a driver in the operating system 318. Otherwise, the BIOS retrieves a password 324. The BIOS encrypts the password 326 and passes the encrypted password to the driver in the operating system 328. In one embodiment, an IDE driver requests the password and receives the encrypted password 306 (shown in FIG. 3A). The IDE driver is part of the operating system. In another embodiment, the password is a system serial number.

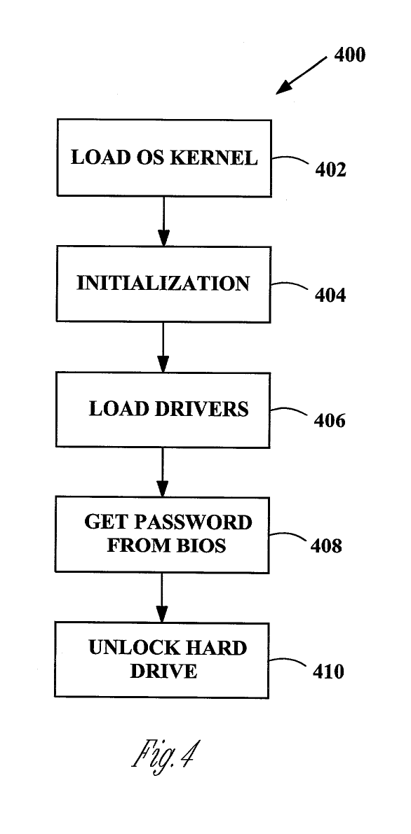

FIG. 4 is another flow chart illustrating an alternate embodiment of the present invention. According to the example method 400 shown in FIG. 4, an operating system kernel 402 is loaded, an initialization component in the operating system kernel 404 is executed, a plurality of drivers 406 are loaded, a password is requested and received from a BIOS 408, and a hard drive is unlocked with the password 410. In one embodiment of the present invention, the password is requested from the BIOS 408, after determining the hard drive is locked. In another embodiment, the operating system kernel is loaded from a flash memory. In another embodiment, a lock mechanism is frozen to prevent tampering with security parameters. Security parameters are those security features described in the ATA commands. In another embodiment, the plurality of drivers include IDE drivers.

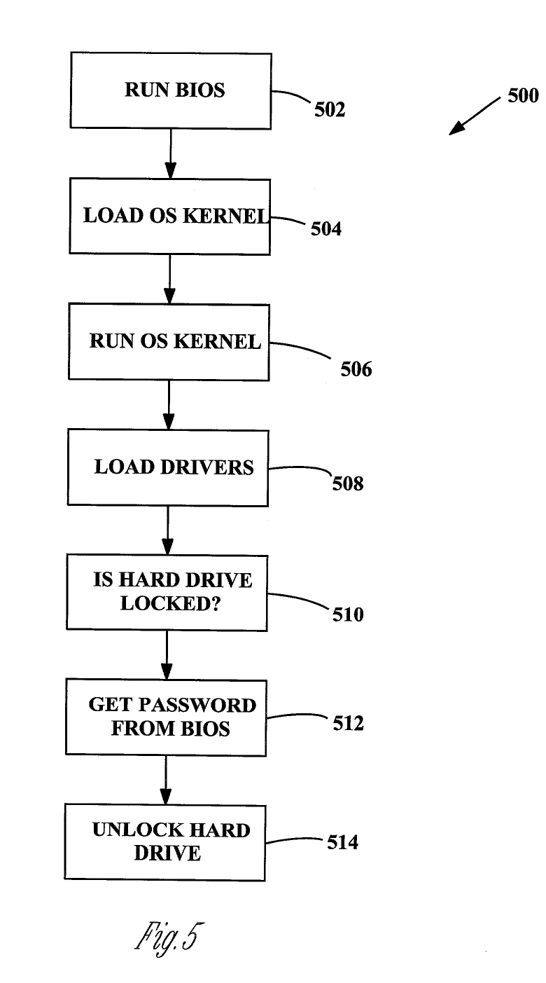

FIG. 5 is another flow chart illustrating a further embodiment of the present invention as an example method 500. A BIOS is executed 502, an operating system kernel is loaded 504 and the operating system kernel is executed 506. At least one IDE driver is loaded 508. A hard drive is queried to determine if it is locked 510. If the hard drive is locked, the BIOS is queried for a password 512. The password is returned from the BIOS to the IDE driver(s) and then the hard drive is unlocked 514. In one embodiment, the BIOS is accessed from the operating system kernel through a system interrupt. In another embodiment, the hard drive is initialized, after it is unlocked. In another embodiment, the computer system boots in approximately three seconds.

It is to be understood that the above description it is intended to be illustrative, and not restrictive. Many other embodiments are possible and some will be apparent to those skilled in the art, upon reviewing the above description. For example other embodiments sharing responsibility between a BIOS and an operating system to unlock a password protected hard drive while still booting quickly include Internet appliances, set-top boxes, home servers, home entertainment centers, and more. Therefore, the spirit and scope of the appended claims should not be limited to the above description. The scope of the invention should be determined with reference to the appended claims, along with the full scope of equivalents to which such claims are entitled.

What is claimed is:

1. A method, comprising:
requesting a password from a basic input-output system (BIOS), after loading an operating system kernel;
receiving the password; and
unlocking a hard drive with the password.

2. The method as recited in claim 1, further comprising:
executing an initialization component in the operating system kernel; and
loading a plurality of drivers.

3. The method as recited in claim 1, further comprising:
determining whether the hard drive is locked;
wherein requesting the password from the basic input-output system (BIOS) is performed after determining the hard drive is locked.

4. The method as recited in claim 1, wherein the operating system kernel is loaded from a flash memory.

5. The method as recited in claim 1, further comprising:
freezing a lock mechanism to prevent tampering with security parameters.

6. The method as recited in claim 1, wherein the plurality of drivers include integrated device electronics (IDE) drivers.

7. A system, comprising:
a processor;
a hard drive coupled to the processor;
an operating system to execute on the processor;
a basic input-output system (BIOS) to execute on the processor;
a password stored in the basic input-output system (BIOS) to unlock the hard drive; and
a driver to execute from the operating system on the processor and to call the basic input-output system (BIOS) to retrieve the password.

8. The system as recited in claim 7, further comprising:
a chassis intrusion mechanism to alternate between a secure mode and a maintenance mode;
wherein the hard drive remains password protected in both the secure mode and the maintenance mode.

9. The system as recited in claim 7, wherein the password is a serial number.

10. The system as recited in claim 7, wherein the password is encrypted.

11. A machine-accessible medium having associated content capable of directing the machine to perform a method, the method comprising:
receiving, by a basic input-output system (BIOS), a hard drive password request from an operating system;
determining, by the basic input-output system (BIOS), if a system is in a maintenance mode;
retrieving, by the basic input-output system (BIOS), a password, when the system is not in a maintenance mode;
encrypting, by the basic input-output system (BIOS), the password; and
passing, by the basic input-output system (BIOS), the encrypted password to the operating system.

12. The machine-accessible medium as recited in claim 11, further comprising:
requesting, by an integrated device electronics (IDE) driver, the password;
receiving, by the integrated device electronics (IDE) driver, the encrypted password;
wherein the integrated device electronics (IDE) driver is part of the operating system.

13. The machine-accessible medium as recited in claim 11, wherein the password is a system serial number.

14. A method, comprising:
determining, by an operating system, that a hard drive is locked;
receiving, by the operating system, a password from a basic input-output system (BIOS); and
unlocking, by the operating system, the hard drive using the password.

15. The method as recited in claim 14, further comprising:
determining, by the operating system, if the password is valid;
wherein unlocking, by the operating system, the hard drive is performed only if the password is valid.

16. The method as recited in claim 14, further comprising:
freezing, by the operating system, a lock mechanism for the hard drive.

17. A method, comprising:
executing a basic input-output system (BIOS);
loading an operating system kernel;
executing the operating system kernel;
loading at least one integrated device electronics (IDE) driver;
querying a hard drive to determine if the hard drive is locked;
if the hard drive is locked, querying the basic input-output system (BIOS) for a password;
returning the password from the basic input-output system (BIOS) to the at least one integrated device electronics (IDE) driver; and
unlocking the hard drive.

18. The method as recited in claim 17, further comprising:
accessing the basic input-output system (BIOS) from the operating system kernel through a system interrupt.

19. The method as recited in claim 18, further comprising:
initializing the hard drive, after unlocking the hard drive.

20. The method as recited in claim 18, wherein the computer system loads the operating system kernel in approximately three seconds.
